(19) United States
(12) Patent Application Publication
(10) Pub. No.: US 2024/0163634 A1
(43) Pub. Date: May 16, 2024

(54) INFORMATION PROCESSING APPARATUS, INFORMATION PROCESSING SYSTEM, INFORMATION PROCESSING METHOD, AND PROGRAM

(71) Applicant: SONY GROUP CORPORATION, TOKYO (JP)

(72) Inventor: KAZUTAKA MITSUIKI, TOKYO (JP)

(21) Appl. No.: 18/551,409

(22) PCT Filed: Feb. 8, 2022
(86) PCT No.: PCT/JP2022/004856

§ 371 Date: Sep. 20, 2023

(30) Foreign Application Priority Data
Mar. 29, 2021 (JP) 2021-055265

(51) Int. Cl. H04S 7/00

(52) U.S. Cl. CPC H04S 7/40

(57) ABSTRACT

The present invention, for example, satisfactorily performs a visual representation that is in alignment with a sound. An information processing apparatus has a visual processing unit configured to, at a time of reproducing audio, obtain information pertaining to a sound for the audio, and use the obtained information pertaining to the sound to generate information for visualizing the information pertaining to the sound.

### TECHNICAL FIELD

The present disclosure pertains to an information processing apparatus, an information, processing system, an information processing method, and a program.

### BACKGROUND ART

In recent years, there is greater interest in improving a bodily sensation for a sound. For example, it is possible to improve a sense of immersion by reproducing a three-dimensional sound field in 3D audio. PTL 1 to PTL 3 described below disclose such techniques for combining a sound with a video.

### CITATION LIST

### Patent Literature

### [PTL 1]

Japanese Translations of PCT for Patent No. 2020-504384

### [PTL 2]

Japanese Patent Laid-open No. 2018-110366

### [PTL 3]

Japanese Translations of PCT for Patent No. 2018-530952

### SUMMARY

### Technical Problem

Incidentally, there are limits in a person's sense of hearing, and it is difficult to accurately recognize a sound. For example, even if a sound is disposed in a 3D space, it is difficult for a human auditory sense to completely understand where the sound is produced.

One objective of the present disclosure is to propose an information processing apparatus, an information processing system, an information processing method, and a program that are capable of satisfactorily performing a visual representation in alignment with a sound.

### Solution to Problem

The present disclosure is, for example, an information processing apparatus including a visual processing unit configured to, at a time of reproducing audio, obtain information pertaining to a sound for the audio, and use the obtained information pertaining to the sound to generate information for visualizing the information pertaining to the sound.

The present disclosure is, for example, an information processing system including an audio reproduction processing unit configured to perform processing for reproduction of audio and a visual processing unit configured to perform processing for generating visual data. The audio reproduction processing unit transmits information pertaining to the sound to the visual processing unit at a time of reproducing the audio. The visual processing unit receives the information pertaining to the sound from the audio reproduction processing unit, and uses the received information pertaining to the sound to generate visual data for visualizing the information pertaining to the sound.

The present disclosure is, for example, an information processing method including, at a time of reproducing audio, obtaining information pertaining to a sound for the audio, and using the obtained information pertaining to the sound to generate information for visualizing the information pertaining to the sound.

The present disclosure is, for example, a program for causing a computer to execute processing for, at a time of reproducing audio, obtaining information pertaining to a sound for the audio, and using the obtained information pertaining to the sound to generate information for visualizing the information pertaining to the sound.

### BRIEF DESCRIPTION OF DRAWINGS

FIG. 1 is a view that illustrates an example of a configuration of an information processing system according to a first embodiment.

FIG. 2 is a view that illustrates an example of a specific configuration of an information processing apparatus on a 3D audio reproduction software side.

FIG. 3 is a view that illustrates an example of a specific configuration of an information processing apparatus on a video software side.

FIG. 4 is a flow chart that illustrates an example of a flow for a preparation process in the information processing apparatus on the 3D audio reproduction software side.

FIG. 5 is a flow chart that illustrates an example of a flow for a reproduction process in the information processing apparatus on the 3D audio reproduction software side.

FIG. 6 is a flow chart that illustrates an example of a flow for a preparation process in the information processing apparatus on the video software side.

FIG. 7 is a flow chart that illustrates an example of a flow for a reproduction process in the information processing apparatus on the video software side.

FIG. 8 is a view that illustrates an example of an overall display for a video at a predetermined timing by a display apparatus.

FIG. 9 is a view that illustrates an example of a partial display for a video at a predetermined timing by the display apparatus.

FIG. 10 is a view that illustrates an example of displaying a video that corresponds to a sound signal level.

FIG. 11 is a view that illustrates an example of displaying a video that corresponds to a sound signal level.

FIG. 12 is a view that illustrates an example of displaying a video that corresponds to a sound type.

FIG. 13 is a view that illustrates an example of displaying a video that corresponds to a sound type.

FIG. 14 is a view that illustrates an example of a configuration of an information processing system according to a second embodiment.

FIG. 15 is a view that illustrates an example of a specific configuration of an information processing apparatus on a 3D audio generation software side.

FIG. 16 is a view that illustrates an example of a configuration of an information processing system according to a third embodiment.

FIG. 17 illustrates an example of a form in which items of software operate in conjunction with each other.

FIG. 18 is a sequence diagram that illustrates an example of a flow of processing in the information processing system according to the third embodiment.

FIG. 19 is a view that illustrates an example of a configuration of an information processing system according to a fourth embodiment.

FIG. 20 illustrates an example of a form in which items of software operate in conjunction with each other.

FIG. 21 is a sequence diagram that illustrates an example of a flow of processing in the information processing system according to the fourth embodiment.

FIG. 22 depicts views each for describing an example of an effect produced by cooperation with a sensor.

FIG. 23 is a view that illustrates an example of a hardware configuration of a computer.

FIG. 24 illustrates a first display example by a display apparatus in a modification.

FIG. 25 illustrates a second display example by a display apparatus in a modification.

FIG. 26 is a view for describing coloring sounds by software.

FIG. 27 illustrates a third display example by a display apparatus in a modification.

### DESCRIPTION OF EMBODIMENTS

With reference to the drawings, description is given below regarding embodiments and the like of the present disclosure. Note that the description will be given in the following order.

### <1. Background>

### <2. First Embodiment>

### <3. Second Embodiment>

### <4. Third Embodiment>

### <5. Fourth Embodiment>

### <6. Computer Hardware Configuration Example>

### <7. Modifications>

The embodiments and the like described below are suitable concrete examples of the present disclosure. Contents in the present disclosure are not limited to these embodiments and the like. Note that, in the following description, the same reference sign is added to items having substantially the same functional configuration, and duplicate description is omitted, as appropriate.

### 1. BACKGROUND

First, description is given regarding the background for the present disclosure. In recent years, attention has been given to 3D audio (three-dimensional sound) that can create a sound field having a superior sense of immersion, such as Dolby Atomos (registered trademark) or 360 Reality Audio (registered trademark). However, even if a sound is disposed in a 3D space, it is difficult for the auditory sense of a human to accurately recognize where a sound is produced, and this is a technical problem. There are 3D audio production tools that are provided with a 3D view in order to visually supplement sound positions, but this is purely requisite minimum functionality for a production tool, and does not improve an auditory experience.

In addition, in a 3D audio editing process or a live performance, there are cases where the position of a sound or the sound itself is changed during reproduction, for example. There are techniques for aligning sound with video, as in, for example, PTL 1 to PTL 3 which are set forth in the background art above. However, there is a technical problem in that, by merely aligning a sound to a video, it is impossible to cause a video to follow a sound in a case where the sound has changed. For example, when a sound for 3D audio is caused to move freely in a live performance, it is difficult to align the position of the sound with a video by simply simultaneous reproducing the video and the sound.

Accordingly, the present disclosure proposes a technique that can solve these technical problems (specifically, a technique for visually supplementing an auditory experience). As something for causing a sense of immersion to arise, there are video apparatuses or applications for causing a video or a sound to change in real time by using sensor information from, for example, a gyro sensor. In particular, the present disclosure is applied to such a video apparatus or application, making it possible to provide supplement that uses a more impactful video as well as an experience having a higher sense of immersion.

### 2. First Embodiment

### [2-1. Information Processing System Configuration Example]

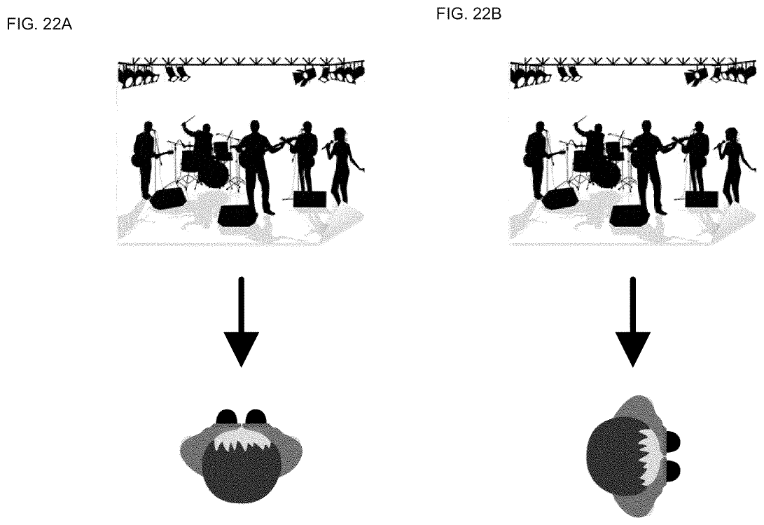

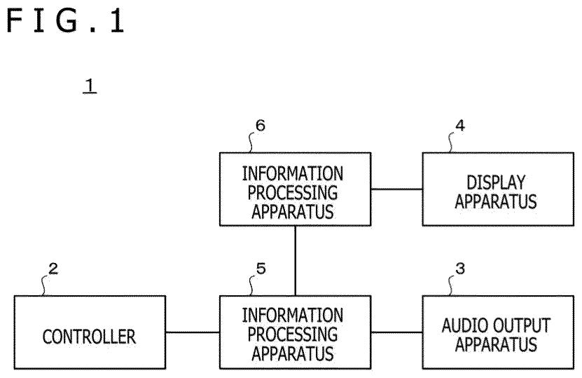

FIG. 1 illustrates an example of a configuration of an information processing system (an information processing system 1) according to a first embodiment. The information processing system 1 visually supplements a 3D audio experience. Note that a specific type of 3D audio does not matter. For example, the 3D audio may be any of object-based, channel-based, and scene-based types. The information processing system 1 is used in, for example, 3D audio editing, a live performance, or the like.

The information processing system 1 employs, as a basic configuration, a 3D audio sound source file, software that can reproduce 3D audio (referred to as 3D audio reproduction software below), and software (referred to as video software below) that can generate a video by obtaining information from the 3D audio reproduction software. The video software is 3D/2D visual software that can generate a 3D or 2D video, for example.

The information processing system 1 has a controller 2, an audio output apparatus 3, a display apparatus 4, an information processing apparatus 5, and an information processing apparatus 6. In the present embodiment, the information processing apparatus 5 has the above-described sound source file and 3D audio reproduction software, and the information processing apparatus 6 has the video software. In other words, in the information processing system 1, the 3D audio reproduction software and the video software are present on separate devices.

The controller 2 is used by a user to edit or operate 3D audio. The controller 2 is configured by a physical controller, for example. As a physical controller, it is possible to use a controller having an operation unit that enables an intuitive operation, such as a knob, a button, or a fader. A controller that has a joystick, which enables a more intuitive operation, as an operation unit may be used. When a physical controller is employed for the controller 2, it is possible to have superior operability in a case of operating on a sound in real time, such as for a live performance or editing of 3D audio, for example.

Note that the controller 2 may be an input device such as a pen tablet, a touch panel, a mouse, or a keyboard. In addition, the controller 2 may be a sensor device that detects a user operation from motion of a user and outputs information regarding a detection result. In such a manner, it is sufficient if the controller 2 can output information that corresponds to an operation performed by a user, and the type of the controller 2 does not matter.

The audio output apparatus 3 stimulates a user's auditory sense. The audio output apparatus 3 is configured by, for example, a speaker that generates vibrations (including a sound), etc.

The display apparatus 4 stimulates a user's visual sense. The display apparatus 4 is configured by, for example, a display (monitor) that displays a still image or a video, etc. The display apparatus 4 may be a typical flat display, or may be an immersive video apparatus for, for example, a VR (Virtual Reality), AR (Augmented Reality), or an MR (Mixed Reality) projection, a dome projection, or a 360-degree projection.

The information processing apparatus 5 and the information processing apparatus 6 are both computer devices (for example, personal computers, television apparatuses, game devices, players, etc.) that perform information processing. The information processing apparatus 5 is connected to the controller 2 and the audio output apparatus 3. The information processing apparatus 6 is connected to the display apparatus 4. The information processing apparatus 5 is also connected to the information processing apparatus 6. Description is given below regarding concrete examples of forms of these connections.

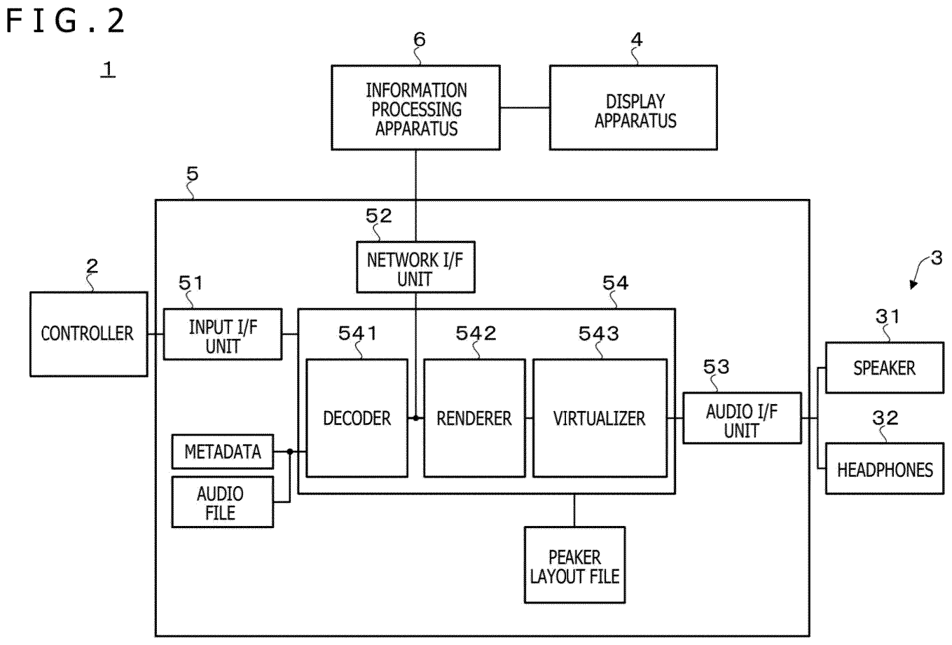

FIG. 2 illustrates an example of a specific configuration of the information processing apparatus 5. The information processing apparatus 5 has an input I/F unit (interface) 51, a network I/F unit 52, and an audio I/F unit 53.

The input I/F unit 51 is an interface (for example, a USB (Universal Serial Bus) interface) for connecting to the controller 2. This interface is not limited to the USB, and may be, for example, Bluetooth (registered trademark) or an IP (Internet Protocol) network, if supported by the controller 2. In such a manner, it is possible to select, as appropriate, the interface between the controller 2 and the information processing apparatus 5. Note that the information processing apparatus 5 and the controller 2 may be connected without going through a general-purpose interface. This similarly applies to other connections.

The network I/F unit 52 is an interface (for example, an interface for IP network communication) for connecting to the information processing apparatus 6. In a case of IP network communication, it is desirable to use UDP (User Datagram Protocol)-based communication, which is connectionless. As a result, it is possible to realize low latency and support real-time processing (specifically, reproduction of a delay-less video that is aligned with a sound). For example, employing OPC (Optimum Power Control), which is an industry standard, as a communication protocol is desirable. As a result, it is possible to contribute to broadening a range of use. This similarly applies to other connections.

Note that it is sufficient if communication between the information processing apparatus 5 and the information processing apparatus 6 is established by a standard that enables information to be exchanged between items of software, and specific communication means does not matter. For example, the communication between them may be established by, for example, Bluetooth (registered trademark), Wi-Fi Direct (registered trademark), a USB, or UNIX (registered trademark) domain sockets. In such a manner, the interface between the information processing apparatus 5 and the information processing apparatus 6 can be selected as appropriate.

The audio I/F unit 53 is an interface for connecting to the audio output apparatus 3. Note that a speaker 31 and headphones 32 are connected, as the audio output apparatus 3, to the information processing apparatus 5. In other words, the audio I/F unit 53 is configured to be able to connect to both the speaker 31 and the headphones 32. The audio I/F unit 53 is configured to be able to generate audio data (specifically, an audio signal) for driving each of the speaker 31 and the headphones 32.

In addition, the information processing apparatus 5 has metadata, an audio file (the sound source file described above), and a speaker layout file (for example, a file representing positions of speakers, the number of the speakers, etc.). These items of data are, for example, used to reproduce 3D audio, and are stored in a storage apparatus (illustration thereof is omitted here) included in the information processing apparatus 5. The audio file is specifically compressed and encoded (for example, compliant with MPEG-H 3D Audio).

The metadata is information pertaining to a sound for 3D audio. For example, the information pertaining to a sound may be information representing the position of the sound (for example, coordinates or a distance and an angle from a reference position), a signal level for the sound, a type of the sound (for example, a type of a musical instrument or an image for the sound), etc. For example, the metadata is set every predetermined number of samples (for example, for each 1024 samples). Note that the metadata may be included in the audio file. For example, in a case of object-based 3D audio, it is possible to use, as metadata, acoustic metadata used in reproducing the 3D audio. As a result, system construction is facilitated.

The information processing apparatus 5 also has an audio reproduction processing unit 54 as a functional block. The audio reproduction processing unit 54 functions when the information processing apparatus 5 executes the 3D audio reproduction software. The audio reproduction processing unit 54 has a decoder 541, a renderer 542, and a virtualizer 543, and performs processing for reproducing audio as follows, for example.

The decoder 541 decodes and outputs the input data. As illustrated in FIG. 2, the decoder 541 is inputted with metadata and an audio file. The renderer 542, on the basis of the metadata, renders and outputs the audio data obtained by the decoding. The virtualizer 543, on the basis of the speaker layout file, virtualizer the rendered audio data and outputs the virtualized audio data to the audio I/F unit 53. As a result, the audio reproduction processing unit 54 generates audio data for realizing three-dimensional sound.

Note that the audio reproduction processing unit 54 has functionality for, on the basis of information that corresponds to a user operation provided from the controller 2 via the input I/F unit 51, rewriting metadata, controlling audio reproduction, and editing or operating on 3D audio. For example, editing or operating on the position of sound is performed as follows.

In a case where the controller 2 is a typical physical controller, it is possible to operate on a position by mapping coordinate information to an operation unit such as a knob or a fader. Specifically, there is adopted a configuration that makes it possible to map coordinate information on the basis of information (hereinafter, referred to as position information, as appropriate) representing the position of a sound included in metadata, and use the operation unit to operate each parameter such as Azimuth (angle in a horizontal direction) and Elevation (vertical movement). There may be adopted a configuration that makes it possible to directly operate on a position using a joystick instead of, for example, a knob or a fader. As a result, it becomes possible to sense position information that correspond to a user operation and use the controller 2 to directly dispose a sound in a 3D space. Note that it is possible to have a similar arrangement for a case of operating (rewriting) other information pertaining to a sound, such as a signal level or a sound type.

In addition, the audio reproduction processing unit 54 provides the information pertaining to a sound to the information processing apparatus 6 at a time of audio reproduction. Specifically, the audio reproduction processing unit 54 has functionality for transmitting the metadata (rewritten metadata in a case where the rewriting described above is performed) to the information processing apparatus 6 via the network I/F unit 52. The metadata transmitted to the information processing apparatus 6 specifically includes, for example, the above-described information representing the position of the sound, a signal level, and a type of the sound.

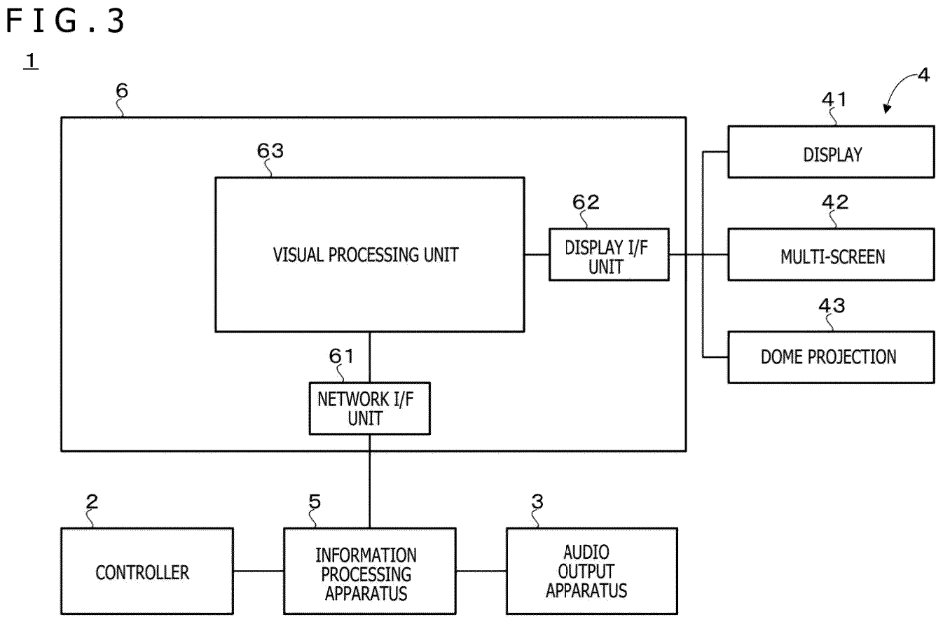

FIG. 3 illustrates an example of a specific configuration of the information processing apparatus 6. The information processing apparatus 6 has a network I/F unit 61 and a display I/F unit 62. The network I/F unit 61 is an interface for connecting to the information processing apparatus 5. The network I/F unit 61 is similar to the network I/F unit 52 described above, and is as described above.

The display I/F unit 62 is an interface for connecting to the display apparatus 4. Note that a display (monitor) 41, a multi-screen 42, and a dome projection 43 are connected as a display apparatus 4 to the information processing apparatus 6. In other words, the display I/F unit 62 is configured in such a manner as to be able to connect the display 41, the multi-screen 42, and the dome projection 43 to each other. The display I/F unit 62 is configured by a display card, for example. The display I/F unit 62 is configured in such a manner as to be able to generate visual data (specifically, a video signal) for driving each of the display 41, the multi-screen 42, and the dome projection 43.

The information processing apparatus 6 has a visual processing unit 63 as a functional block. The visual processing unit 63 functions when the information processing apparatus 6 executes video software. The visual processing unit 63 has functionality for, at a time of audio reproduction, obtaining the above-described metadata, in other words, the information pertaining to a sound, and using the obtained information pertaining to the sound to generate information for visualizing the information pertaining to the sound.

Specifically, the visual processing unit 63 has functionality for using the metadata obtained from the information processing apparatus 5 via the network I/F unit 61, to generate visual data, and outputting the visual data to the display I/F unit 62. In the present embodiment, the visual processing unit 63 generates visual data for visualizing information representing the position of the sound, a signal level, and a type of the sound. Description regarding an example of displaying by the display apparatus 4 with use of this generated visual data is given below.

### [2-2. Example of Flow of Processing in Information Processing System]

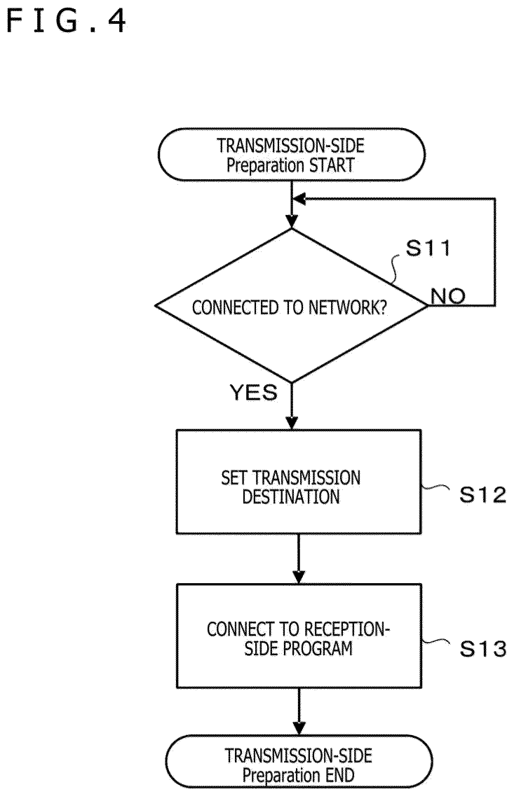

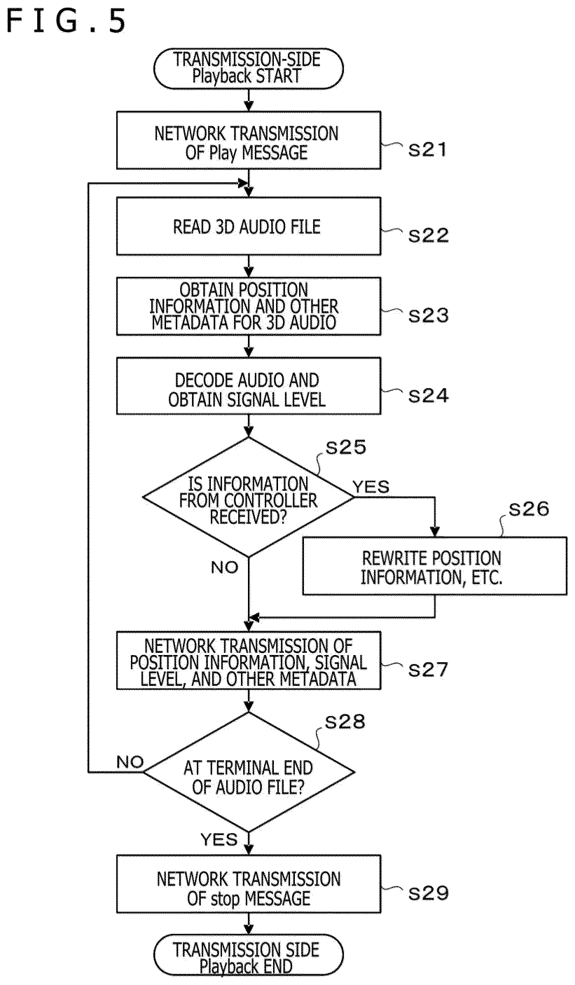

Firstly, with reference to FIG. 4 and FIG. 5, description is given regarding a flow of processing in the information processing apparatus 5, which will serve as a transmitter of metadata. Note that description is given here divided into two: a preparation phase (a preparation process) illustrated in FIG. 4 and a reproduction (Playback) phase (reproduction process) illustrated in FIG. 5. The preparation phase is performed before the reproduction phase.

As illustrated in FIG. 4, firstly, the audio reproduction processing unit 54 in the information processing apparatus 5 determines whether or not the information processing apparatus 5 is connected to a network (step S11). In a case of determining that a connection has been made to the network (YES), the audio reproduction processing unit 54 sets a transmission destination (step S12). For example, in a case of an IP network connection, setting and the like are performed for an IP address and port for the information processing apparatus 6, which will be the transmission destination. Next, the audio reproduction processing unit 54 connects to a program (video software) on the information processing apparatus 6 side which will serve as a receiver of metadata (step S13), completes pre-reproduction preparation, and transitions to a reproduction phase.

As illustrated in FIG. 5, in the reproduction phase, the audio reproduction processing unit 54 firstly uses the network I/F unit 52 to perform a network transmission of a play message to the information processing apparatus 6 (step S21). Next, the audio reproduction processing unit 54 reads and obtains an audio file for 3D audio from, for example, a storage apparatus (step S22). In addition, metadata that includes position information regarding the 3D audio and other information are obtained (step S23). Then, the audio reproduction processing unit 54 uses the decoder 541 to decode the audio file and obtain a signal level (step S24). In such a manner, the signal level for a sound is specifically obtained by decoding the audio file, and added to the metadata.

Here, the audio reproduction processing unit 54 determines whether or not information has been received from the controller 2 (step S25) and, in a case of determining that the information has been received (YES), rewrites such metadata as the position information on the basis of the received information (step S26).

After the rewriting according to step S26 or in a case where it is determined in step S25 that no information has been received from the controller 2 (NO), the audio reproduction processing unit 54 uses the network I/F unit 52 to perform a network transmission of the metadata that includes the position information, the signal level, and the other information (step S27).

Then, the audio reproduction processing unit 54 determines whether or not the end of the audio file has been reached (step S28) and, in a case of not being at the end (NO), returns the processing to step S22 and continues the reproduction process. In contrast, in a case where it is determined in step S28 that the end of the audio file has been reached (YES), the audio reproduction processing unit 54 uses the network I/F unit 52 to perform a network transmission of a stop message to the information processing apparatus 6 (step S29), and ends the reproduction process.

Note that the audio data obtained by being decoded in step S24 is rendered by the renderer 542, is virtualized by the virtualizer 543, and is outputted to the audio output apparatus 3 via the audio I/F unit 53. As a result, three-dimensional sound is realized.

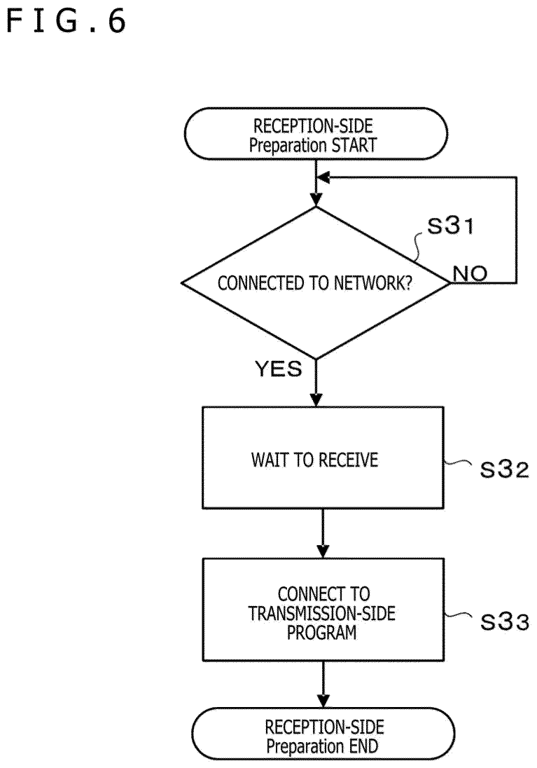

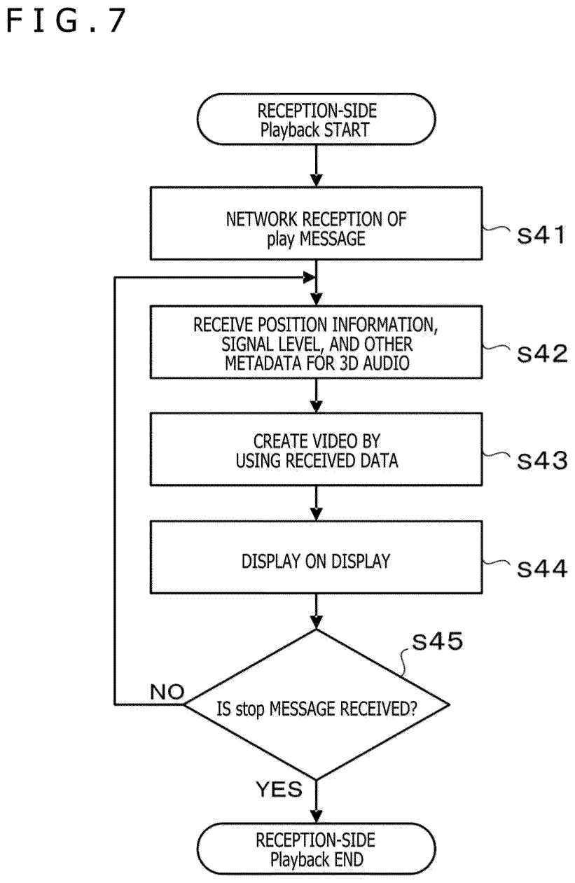

Next, with reference to FIG. 6 and FIG. 7, description is given regarding a flow of processing in the information processing apparatus 6, which will serve as a receiver of metadata. The video software in the information processing apparatus 6 performs processing in conjunction with the 3D audio reproduction software in the information processing apparatus 5. Note that description is also given here divided into two: a preparation phase (a preparation process) illustrated in FIG. 6 and a reproduction (Playback) phase (reproduction process) illustrated in FIG. 7. As described above, the preparation phase is performed before the reproduction phase.

As illustrated in FIG. 6, firstly, the visual processing unit 63 in the information processing apparatus 6 determines whether or not the information processing apparatus 6 is connected to the network (step S31). Then, the visual processing unit 63 enters a waiting-to-receive state (step S32) in a case of determining that there is a connection to the network (YES). For example, in a case of an IP network connection, a receiving port is opened. Next, the visual processing unit 63 connects to a program (3D audio reproduction software) on the information processing apparatus 5 side which will serve as a transmitter of metadata (step S33), completes pre-reproduction preparation, and transitions to a reproduction phase.

As illustrated in FIG. 7, in the reproduction phase, the visual processing unit 63 firstly uses the network I/F unit 61 to perform network reception of a play message transmitted from the information processing apparatus 5 (step S41). Next, the visual processing unit 63 uses the network I/F unit 61 to receive metadata that includes position information and a signal level for 3D audio as well as other information and that has been transmitted from the information processing apparatus 5 (step S42). At this time, the visual processing unit 63 receives and obtains the metadata by using connectionless network communication, for example.

Then, the visual processing unit 63 uses the received metadata to generate visual data (video) (step S43), and displays the generated visual data by outputting the visual data to the display apparatus 4 via the display I/F unit 62 (step S44). Here, the visual processing unit 63 obtains, in other words, receives, the metadata in real time at a time of audio reproduction, for example. A design for receiving metadata in real time is employed, making it possible to realize real-time following even in a case of 3D audio editing or a live performance in which the position of a sound or the sound itself changes in real time.

Then, the visual processing unit 63 determines whether or not a stop message has been received from the information processing apparatus 5 (step S45), and continues the reproduction process by returning the process to step S42 in a case where a stop message has not been received (NO). In contrast, in a case where it is determined in step S45 that a stop message has been received (YES), the visual processing unit 63 ends the reproduction process. As a result, a video is displayed by the display apparatus 4 in conjunction with a sound outputted from the audio output apparatus 3.

### [2-3. Examples of Displaying by Display Apparatus]

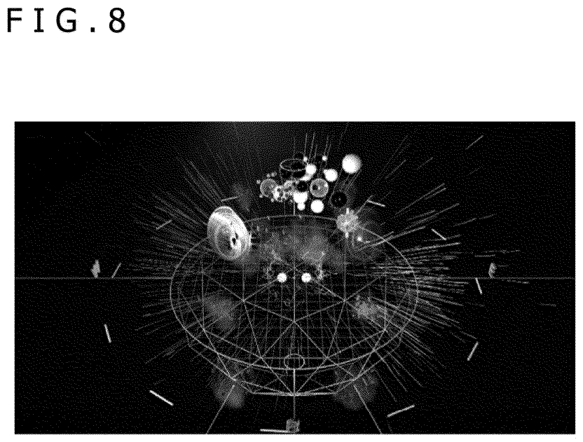

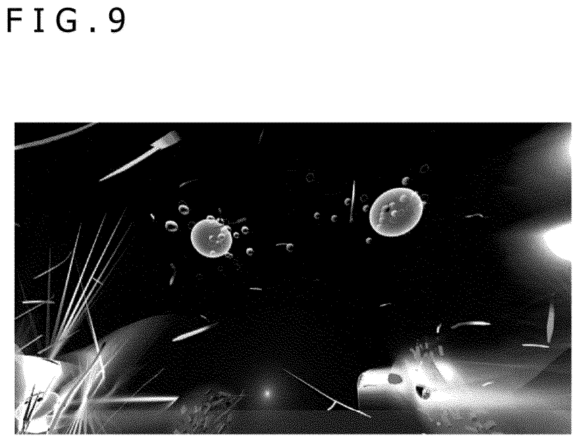

FIG. 8 and FIG. 9 each illustrate an example of displaying a video at a predetermined timing by the display apparatus 4. Note that FIG. 8 is an example of an overall display while FIG. 9 is an example of a partial display. The videos illustrated in FIG. 8 and FIG. 9 are specifically generated with use of information representing the position of a sound, a signal level, and a sound type which are included in metadata.

For example, locations for disposing individual images (parts) are set on the basis of position information, and represent positions of sound sources. In other words, locations where individual images are disposed are locations where sounds are emitted. As a result, it is possible to accurately convey the position and motion for a sound to a user by supplementing them visually.

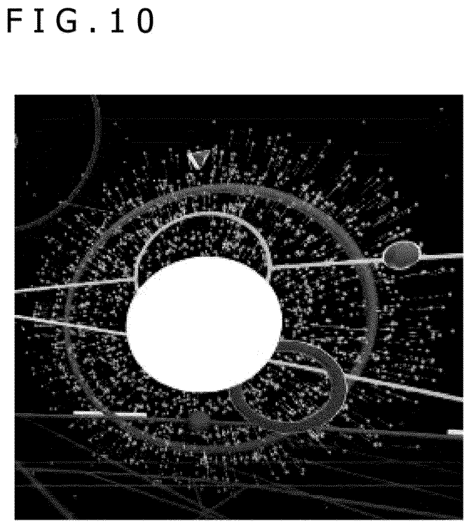

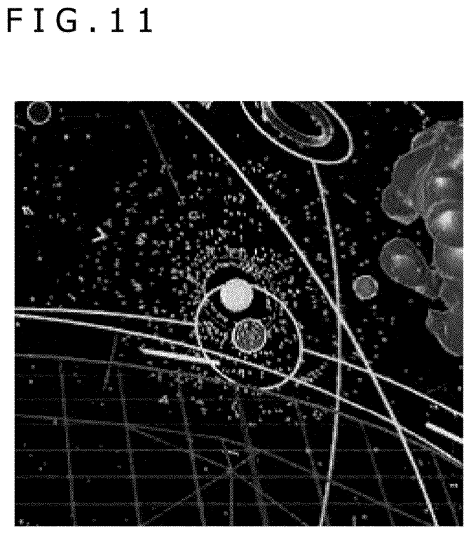

Further, in another example, the sizes of individual images are set on the basis of the signal levels. For example, a sound having a high signal level is displayed large as illustrated in FIG. 10, and a sound having a low signal level is displayed small as illustrated in FIG. 11. As a result, it is possible to accurately convey strength for a sound to a user by supplementing visually.

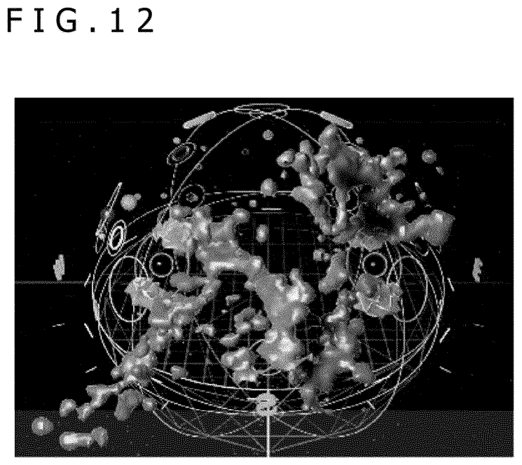

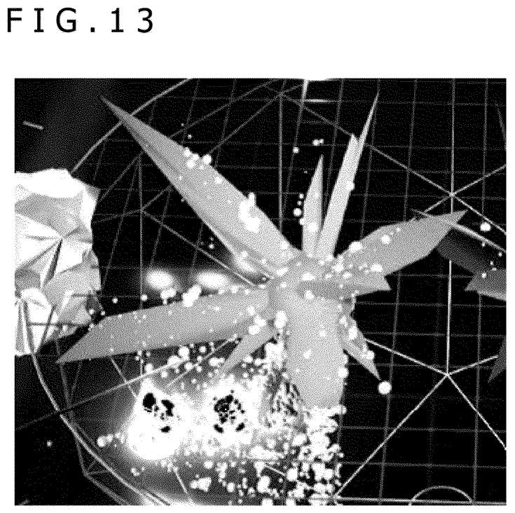

Moreover, in still another example, the shapes of individual images are set on the basis of types of sounds. For example, in a case of a striking sound such as the one with a drum or percussion, as illustrated in FIG. 10 and FIG. 11, an exploding video (for example, a video in which a circular image depicting a drum is displayed and disappears in alignment with a strike timing) is displayed. For example, in a case of a cosmic sound, a video having a shape that expands in a space is displayed as illustrated in FIG. 12, and in a case of a sound having an edgy sound such as the one with a piano, a video having a sharp shape is displayed as illustrated in FIG. 13. As a result, it is possible to accurately convey a type of a sound to a user by supplementing it visually.

Note that detailed description is omitted regarding a specific method for generating a video, but, for example, consideration can be given to a method in which a material is prepared in advance in alignment with a sound in, for example, a storage apparatus (illustration thereof is omitted here) included in the information processing apparatus 6 and is merely corrected according to metadata (such as position information, for example) received from the 3D audio reproduction software. Note that there may be, for example, a method in which metadata that includes position information, a signal level, a sound type, and other information and that is received from the 3D audio reproduction software is used at a reception timing to create video on the spot.

### [2-4. Effects]

In the information processing system 1 according to the present embodiment, the video software on the information processing apparatus 6 side generates a video by using metadata that includes, for example, position information provided from the 3D audio reproduction software on the information processing apparatus 5 side. As a result, it is possible for the information processing apparatus 6 to generate a video in conjunction with a 3D audio sound reproduced by the information processing apparatus 5. Accordingly, for example, by visualizing, according to video, for example, position information for a sound which is difficult to convey completely by sound alone, an auditory experience is visually supplemented, and an auditory and video experience having a sense of immersion becomes possible.

In addition, the metadata is communicated by a UDP-based network protocol, making it possible to realize low latency. Hence, it is possible for a sound and a video to be generated in conjunction with each other even in a case where the 3D audio reproduction software and the video software are present on different devices (the information processing apparatus 5 and the information processing apparatus 6).

Metadata is transmitted as information from the information processing apparatus 5 to the information processing apparatus 6 in real time, making it possible to, for example, cause a video to follow a sound even in a case of where there is usage in, for example, editing work or a live performance that, on the spot, uses a live sound source for a song or a musical instrument or moves a sound.

### 3. Second Embodiment

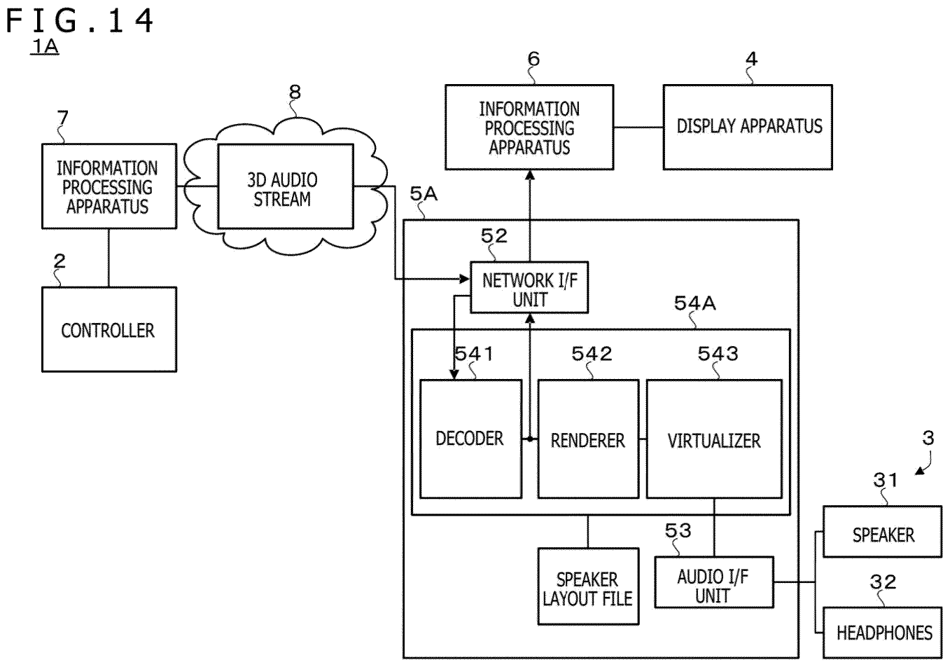

FIG. 14 illustrates an example of a configuration of an information processing system (an information processing system 1A) according to a second embodiment. The information processing system 1A has a controller 2, an audio output apparatus 3, a display apparatus 4, an information processing apparatus 5A, an information processing apparatus 6, an information processing apparatus 7, and a cloud storage 8. The information processing system 1A is used in, for example, live streaming, etc.

The information processing system 1A in the present embodiment differs to the information processing system 1 according to the first embodiment in that the information processing apparatus 5A, which corresponds to the information processing apparatus 5 according to the first embodiment, performs streaming reproduction of 3D audio, and that the controller 2 is connected to the information processing apparatus 7. Remaining points are essentially the same as those in the first embodiment. Description is given in detail below regarding the differences.

The information processing apparatus 5A has a network I/F unit 52, an audio I/F unit 53, and a speaker layout file. The information processing apparatus 5A also has an audio reproduction processing unit 54A instead of the audio reproduction processing unit 54 in the first embodiment. The audio reproduction processing unit 54A has a decoder 541, a renderer 542, and a virtualizer 543.

The audio reproduction processing unit 54A has functionality for streaming (receiving) 3D audio stream data from the cloud storage 8 via the network I/F unit 52 and providing the stream data to the decoder 541. This stream data includes metadata and an audio file, which are described above.

The audio reproduction processing unit 54A obtains the metadata, which includes position information and other information, by streaming the 3D audio stream data from the cloud storage 8 and decoding the stream data by the decoder 541. Other processing is the same as for the audio reproduction processing unit 54 in the first embodiment.

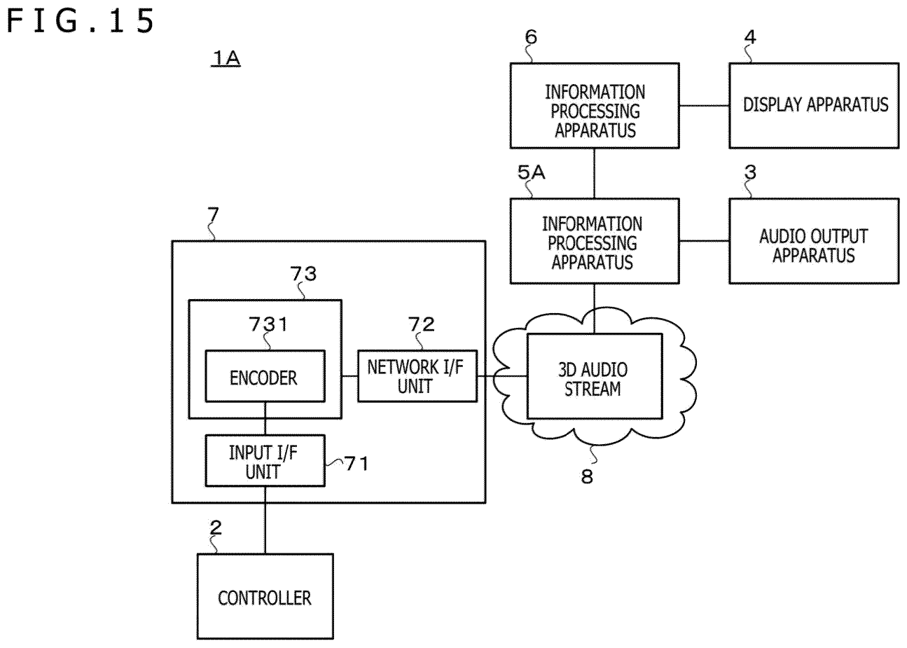

FIG. 15 illustrates an example of a specific configuration of the information processing apparatus 7. The information processing apparatus 7 is a computer (for example, a personal computer) that performs information processing. The information processing apparatus 7 is connected to the controller 2 and the cloud storage 8. The information processing apparatus 7 has an input I/F unit 71 and a network I/F unit 72.

The input I/F unit 71 is similar to the input I/F unit 51 in the information processing apparatus 5 described in the first embodiment, and is as described above. The network I/F unit 72 is an interface (for example, an interface for IP network communication) for connecting to the cloud storage 8. The network I/F unit 72 is similar to the network I/F unit 52 in the information processing apparatus 5 described in the first embodiment, and is as described above. Note that the information processing system 1A may have a configuration in which the information processing apparatus 7 is a cloud server and directly distributes 3D audio stream data to the information processing apparatus 5A.

The information processing apparatus 7 has an audio generation processing unit 73 as a functional block. The audio generation processing unit 73 functions when the information processing apparatus 7 executes 3D audio generation software that can generate 3D audio stream data. The audio generation processing unit 73 has an encoder 731.

The encoder 731 uses pre-prepared metadata and an audio file to generate 3D audio stream data, and outputs the 3D audio stream data to the cloud storage 8 via the network I/F unit 72. The metadata and the audio file are, for example, recorded in advance and are stored in, for example, a storage apparatus (illustration thereof is omitted here) in the information processing apparatus 7. There is no limitation to this, and a live sound source such as a song or a musical instrument may be inputted and disposed in 3D audio.

Note that the audio generation processing unit 73 has functionality for, according to information provided from the controller 2 via the input I/F unit 71, rewriting metadata and editing or operating on 3D audio. This editing or operating is the same as that described in the first embodiment. As a result, it is possible to support live streaming in which the position of a sound, etc., is moved in real time, for example.

In the information processing system 1A according to the present embodiment, the relation between the 3D audio reproduction software executed by the information processing apparatus 5A and the video software executed by the information processing apparatus 6 is the same as that in the information processing system 1 in the first embodiment described above. Accordingly, it is possible to achieve a similar effect to that of the first embodiment described above, even in the information processing system 1A which can be used even with live streaming.

### 4. Third Embodiment

### [4-1. Information Processing System Configuration Example]

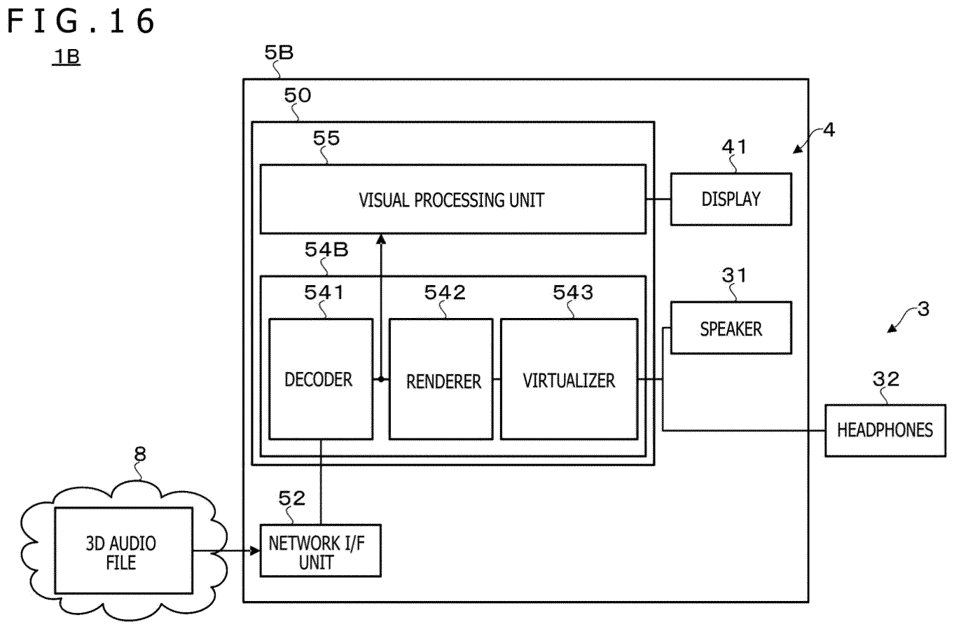

FIG. 16 illustrates an example of a configuration of an information processing system (an information processing system 1B) according to a third embodiment. The information processing system 1B has an audio output apparatus 3, an information processing apparatus 5B, and a cloud storage 8. In the present embodiment, headphones 32, as the audio output apparatus 3, are connected to the information processing apparatus 5B. In addition, an audio file for 3D audio is placed in the cloud storage 8. Note that this audio file includes the metadata described above.

The information processing apparatus 5B is a computer device (for example, a smartphone, a tablet computer, a personal computer, or the like) that performs information processing. The information processing apparatus 5B has the speaker 31 which serves as the audio output apparatus 3, a display 41 which serves as a display apparatus 4, and a network I/F unit 52. In such a manner, the audio output apparatus 3 and the display apparatus 4 may be incorporated in the information processing apparatus 5B.

The information processing apparatus 5B has an audio/visual processing unit 50 as a functional block. The audio/visual processing unit 50 functions when the information processing apparatus 5B executes a 3D audio/video application (software that can reproduce 3D audio and reproduce a 3D or 2D video). The audio/visual processing unit 50 has an audio reproduction processing unit 54B and a visual processing unit 55.

The audio reproduction processing unit 54B functions as a 3D audio player that can reproduce 3D audio by using an audio playback engine. The audio reproduction processing unit 54B has a decoder 541, a renderer 542, and a virtualizer 543, and has similar functionality to the audio reproduction processing unit 54A in the second embodiment described above.

The visual processing unit 55 has functionality for generating a 3D or 2D video by using a graphics engine (Graphic Engine). The visual processing unit 55 has similar functionality to the visual processing unit 63 in the first embodiment described above.

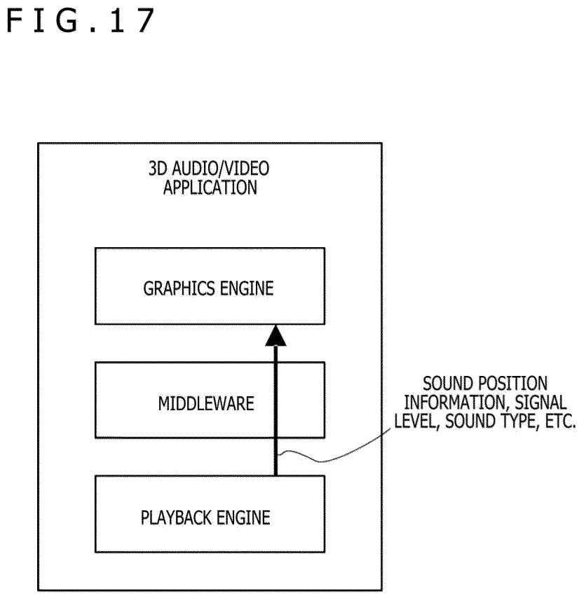

FIG. 17 illustrates an example of a form in which items of software operate in conjunction with each other. As illustrated in FIG. 17, in the information processing system 1B, metadata that includes position information for a sound, a signal level, a sound type, and other information is provided, via middleware, from a playback engine that can reproduce 3D audio to a graphics engine that generates a video. In other words, the audio/visual processing unit 50 has functionality for causing the playback engine and the graphics engine to operate in conjunction with each other within the same application (the 3D audio/video application). In such a manner, in the present embodiment, the metadata is communicated with use of inter-module communication within the same application. In other words, cooperation between the 3D audio reproduction software and the video software is not limited to cooperation between applications on different devices described in the first embodiment and the second embodiment which are described above, and various forms can be taken.

### [4-2. Example of Flow of Processing in Information Processing System]

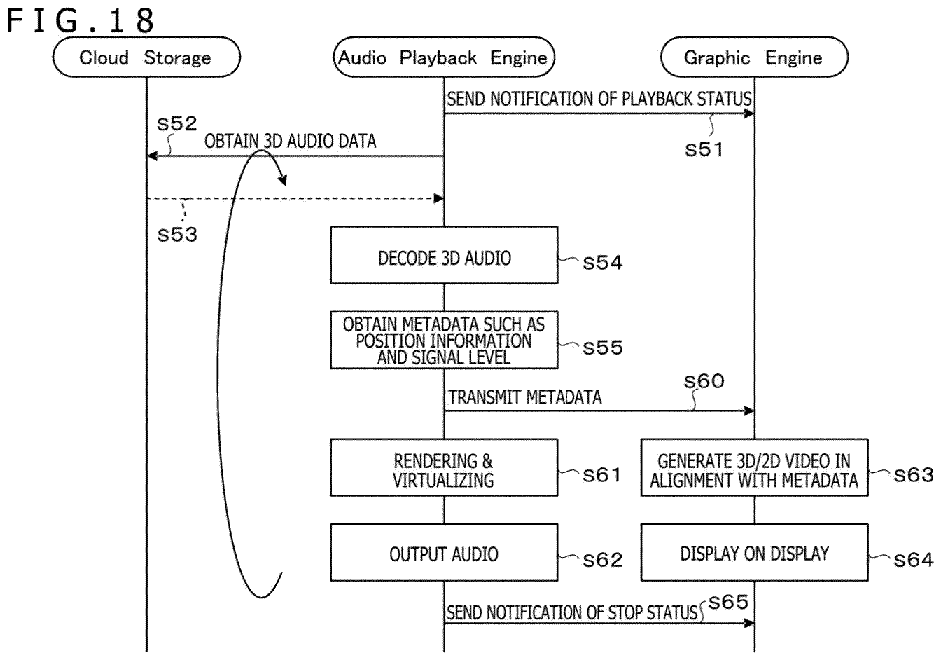

FIG. 18 is a sequence diagram that illustrates an example of a flow of processing in the information processing system 1B. As illustrated in FIG. 18, first, when the audio playback engine (the audio reproduction processing unit 54B) in the information processing apparatus 5B starts reproducing 3D audio, notification of a playback status is sent from the audio playback engine to the graphics engine (the visual processing unit 55) (step S51).

Then, when reception of 3D audio data (an audio file) from the cloud storage 8 is started by the audio playback engine (step S52), the 3D audio data is received with use of the network I/F unit 52 (step S53).

The audio playback engine uses the decoder 541 to decode the 3D audio data that has been obtained by this reception (step S54). Next, the audio playback engine obtains metadata that includes position information, a signal level, and other information (step S55). Then, the metadata is transmitted from the audio playback engine to the graphics engine (step S60).

The audio playback engine next uses the renderer 542 to render the decoded audio data, and performs virtualization by using the virtualizer 543 (step S61). Then, the audio playback engine performs audio output of the virtualized audio data (outputs the virtualized audio data to the audio output apparatus 3) (step S62).

Meanwhile, the graphics engine receives the metadata, generates a 3D or 2D video (visual data) in alignment with the received metadata (step S63), and displays the video on a display (outputs the video to the display 41) (step S64). Then, when reproduction by the audio playback engine ends, notification of a stop status is sent from the audio playback engine to the graphics engine (step S65), and reproduction processing by the audio playback engine and the graphics engine ends.

In the information processing system 1B according to the present embodiment, the audio reproduction processing unit 54B functions similarly to the audio reproduction processing unit 54A in the second embodiment described above. In addition, the visual processing unit 55 functions similarly to the visual processing unit 63 in the first embodiment described above. Accordingly, it is possible to achieve an effect that is similar to that for the other embodiments described above, even in the information processing system 1B in which the 3D audio reproduction software and the video software coexist within the same application (the 3D audio/video application) in the same device (the information processing apparatus 5B).

### 5. Fourth Embodiment

### [5-1. Information Processing System Configuration Example]

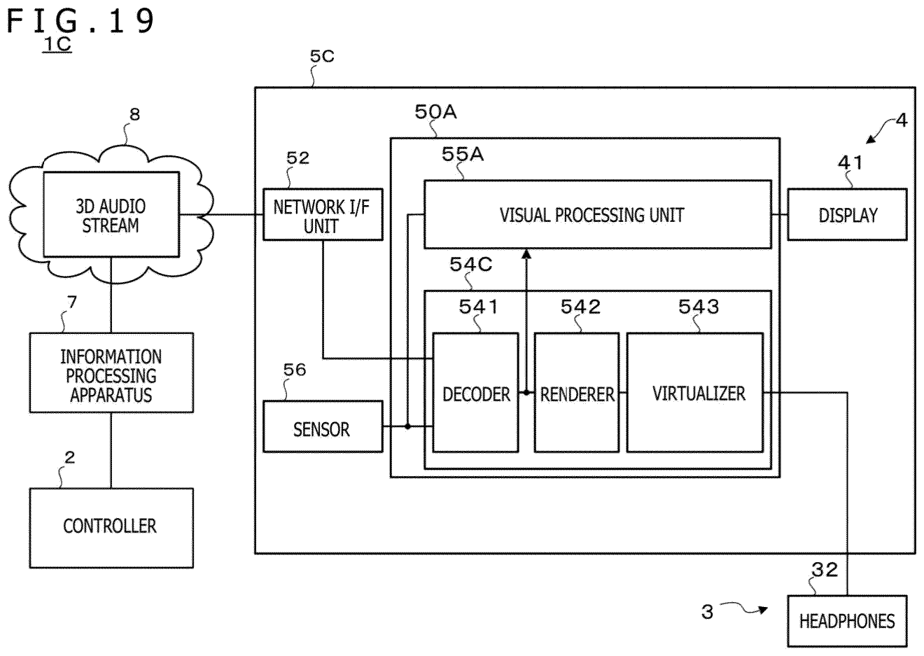

FIG. 19 illustrates an example of a configuration of an information processing system (an information processing system 10) according to a fourth embodiment. The information processing system 10 has a controller 2, an audio output apparatus 3, an information processing apparatus 5C, an information processing apparatus 7, and a cloud storage 8. In the present embodiment, headphones 32, as the audio output apparatus 3, are connected to the information processing apparatus 5C. The controller 2, the information processing apparatus 7, and the cloud storage 8 are the same as those described with reference to FIG. 15 in the second embodiment which is described above. In other words, the controller 2 and the cloud storage 8 are connected to the information processing apparatus 7, and the information processing apparatus 7 generates 3D audio stream data and outputs the 3D audio stream data to the cloud storage 8.

The information processing apparatus 5C is a computer device that performs information processing. For example, the information processing apparatus 5C is a head-mounted display, a smartphone, or the like that is capable of a virtual experience that is VR, AR, MR, or the like. The information processing apparatus 5C has a display 41 which serves as a display apparatus 4, a network I/F unit 52, and a sensor 56.

The sensor 56 detects motion of a user who holds the information processing apparatus 5C. As the sensor 56, for example, a gyro sensor that detects angular velocity is used. Note that it is sufficient if, for example, the sensor 56 is something that can detect motion (for example, an angle, a direction, or the like) of a user, such as a tilt sensor, an inertial sensor, or a geomagnetic sensor, and the type thereof does not matter.

The information processing apparatus 5C has an audio/visual processing unit 50A as a functional block. The audio/visual processing unit 50A functions by the information processing apparatus 5C executing a 3D audio/video application or a VR/AR/MR application. The 3D audio/video application, for example, functions in conjunction with the VR/AR/MR application. Note that the VR/AR/MR application itself may function as the 3D audio/video application.

The audio/visual processing unit 50A has an audio reproduction processing unit 54C and a visual processing unit 55A. The audio reproduction processing unit 54C and the visual processing unit 55A both differ from the audio reproduction processing unit 54B and the visual processing unit 55 in the above-described third embodiment in performing processing after being inputted with output information from the sensor 56, and are the same in other points. In the information processing system 10, a video in the video software or a sound in the 3D audio reproduction software in the information processing apparatus 5C change on the basis of output information from the sensor 56.

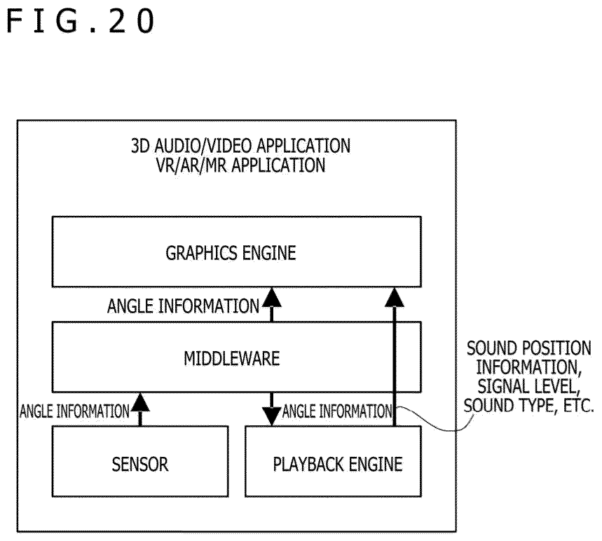

FIG. 20 illustrates an example of a form in which software operate in conjunction with each other. As illustrated in FIG. 20, similarly to the audio/visual processing unit 50 according to the third embodiment, the audio/visual processing unit 50A provides metadata that includes position information for a sound, a signal level, a sound type, and other information from a playback engine to a graphics engine, via middleware.

In addition, in the audio/visual processing unit 50A, as information representing motion of a user, angle information is provided from the sensor 56 to the playback engine and the graphics engine, via the middleware. In other words, the audio reproduction processing unit 54C and the visual processing unit 55A obtain angle information from the sensor 56. This angle information, for example, represents angular velocity and acceleration or angles for three axes (an a axis, a 3 axis, and a y axis which are orthogonal to each other) which represent motion of the information processing apparatus 5C. In such a manner, the audio/visual processing unit 50A has functionality for causing the playback engine and the graphics engine to operate in conjunction with each other and causing the sensor 56, the playback engine, and the graphics engine to operate in conjunction with each other.

### [5-2. Example of Flow of Processing in Information Processing System]

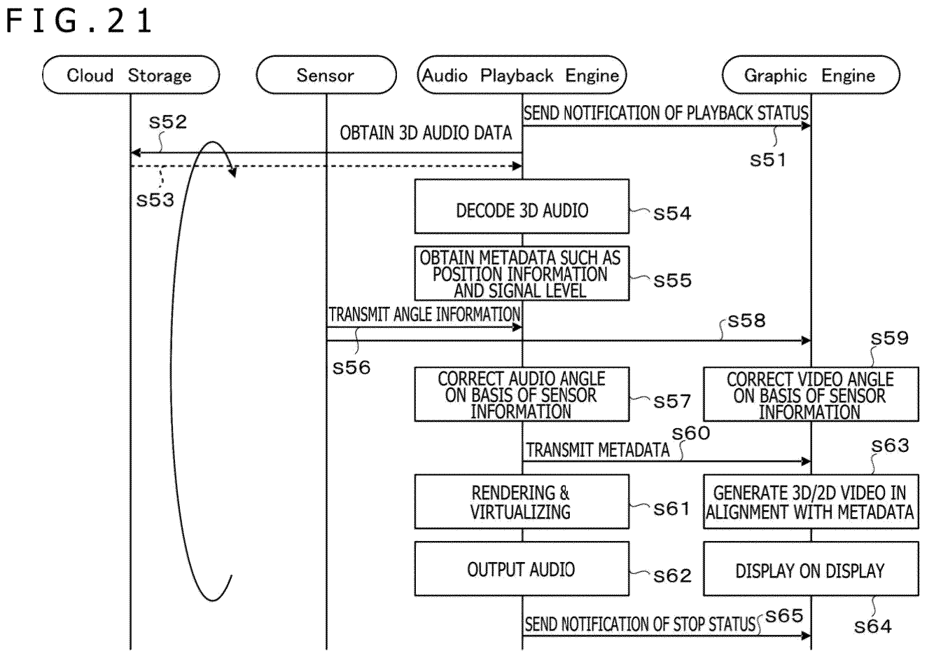

FIG. 21 is a sequence diagram that illustrates an example of a flow of processing in the information processing system 10. The processing illustrated in FIG. 21 differs from that described (with reference to the FIG. 18) in the third embodiment described above, in that processing from step S56 to step S59 has been added. Other points are the same.

In the present embodiment, the audio playback engine obtains metadata that includes position information, a signal level, and other information (step S55), subsequently obtains angle information from the sensor 56 (step S56), and performs an audio angle correction that is based on the obtained angle information (step S57). In conjunction with this, the graphics engine also obtains this angle information (step S58), and performs a video angle correction that is based on the obtained angle information (step S59). Specifically, the audio playback engine and the graphics engine each perform an angle correction to thereby make conversions to audio and a video that correspond to motion such as the angle and direction of a user's face. At this time, the audio playback engine rewrites metadata as necessary. In other words, the metadata is corrected on the basis of information representing motion of a user. The audio playback engine transmits the metadata to the graphics engine (step S60). In other words, the corrected metadata is provided to the visual processing unit 55A. Subsequent processing is the same as that described with reference to FIG. 18. Note that the visual processing unit 55A generates visual data for displaying a VR, AR, or MR image, and, on the basis of the angle information, corrects the generated visual data for displaying a VR, AR, or MR image.

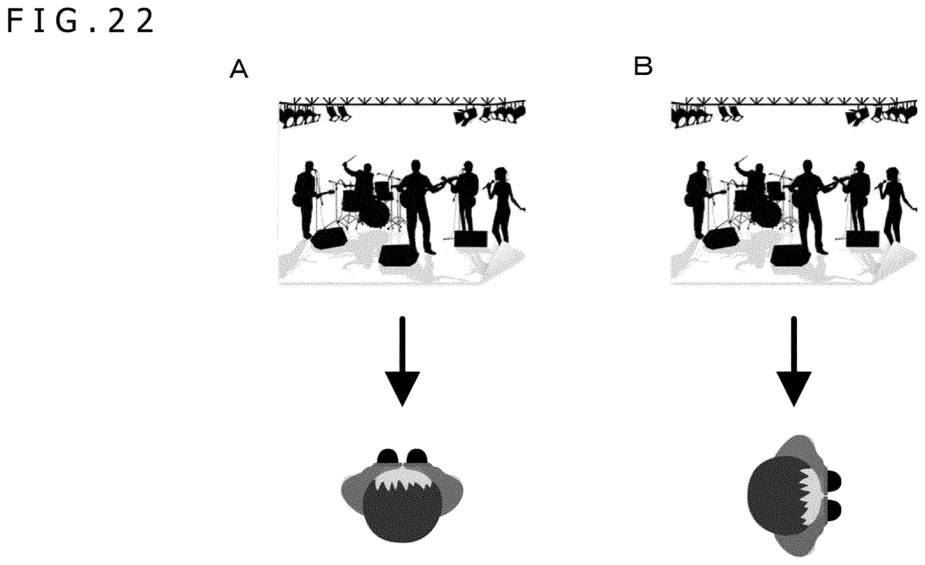

FIG. 22 depicts views each for describing an example of an effect produced by cooperation with the sensor 56. Note that description is given here by taking, as an example, a case of using the information processing apparatus 5C to view a VR/AR/MR video for a live stage such as a concert. FIG. 22A illustrates a state in which the user is facing a stage, and FIG. 22B illustrates a state in which the user is facing 90 degrees to the right from the state illustrated in FIG. 22A.

For example, audio is converted such that a sound is heard from in front when the user is facing the stage as illustrated in FIG. 22A and that a sound is heard from a left-ear side, in other words, mainly from the left ear, when the user's body is rotated 90 degrees to the right (facing laterally) as illustrated in FIG. 22B. As a result, an experience having a more real sense of actually being there becomes possible.

In such a manner, by changing, for example, a video or a sound such as that from a VR/AR/MR apparatus or a video or a sound for a smartphone in conjunction with position information and changing the position of a 3D audio sound and a video in conjunction with each other, it is possible to enable, for example, the position of the sound to be realistically recognized even in a virtual immersive space such as that for VR/AR/MR.

In the information processing system 10 according to the present embodiment, the audio/visual processing unit 50A functions similarly to the audio/visual processing unit 50 in the third embodiment described above. Accordingly, it is possible to achieve a similar effect to that of the third embodiment described above. In addition, the sensor 56 cooperates with the audio playback engine and the graphics engine. As a result, in the information processing apparatus 5C, in addition to using output information from the sensor 56 to correct the position of a sound, the correction information (specifically, the output information from the sensor 56) is transmitted in real time to the video software, and it is possible to use the correction information and the metadata to create a video. Accordingly, for example, an immersive video apparatus or application that has a three-dimensional visual effect performs visualization of a video having, for example, position information for a sound, making it possible to supplement with a stronger auditory experience and enable a sound and video experience having a sense of immersion.

### <6. Computer Hardware Configuration Example>

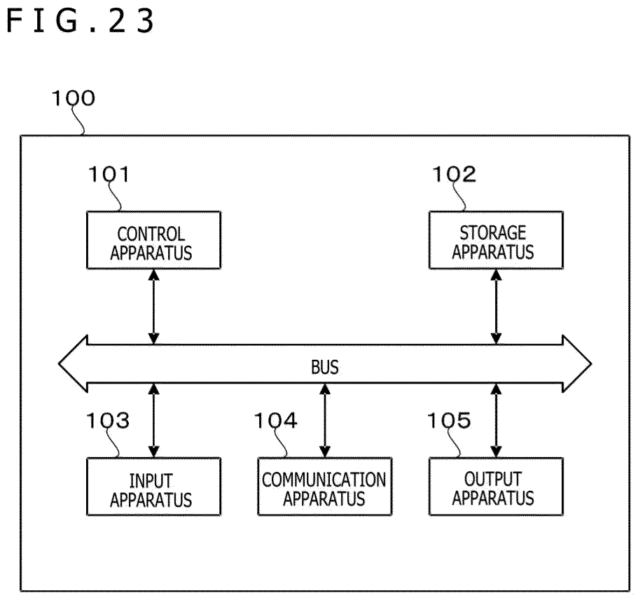

FIG. 23 illustrates an example of a hardware configuration of a computer (a computer 100) that can be employed as an information processing apparatus (the information processing apparatuses 5, 5A, 5B, 5C, 6, and 7) according to the embodiments described above. The computer 100 has a control apparatus 101, a storage apparatus 102, an input apparatus 103, a communication apparatus 104, and an output apparatus 105 which are interconnected by a bus.

The control apparatus 101 includes, for example, a CPU (Central Processing Unit), a RAM (Random-Access Memory), a ROM (Read-Only Memory), and the like. The ROM stores, for example, a program that is read in and operated by the CPU. The RAM is used as a work memory for the CPU. The CPU controls the entirety of the computer 100 by executing various kinds of processing according to the program stored in the ROM and issuing commands.

The storage apparatus 102 is, for example, a storage medium including an HDD (Hard Disc Drive), an SSD (Solid-State Drive), a semiconductor memory, or the like, and saves data for a program (for example, an application) or the like in addition to content data such as image data, video data, audio data, and text data.

The input apparatus 103 is an apparatus for inputting various kinds of information to the computer 100. When information is inputted by the input apparatus 103, the control apparatus 101 performs various processes that correspond to the input information. In addition to a mouse and a keyboard, the input apparatus 103 may be, for example, a touch screen resulting from integrally configuring a touch panel and a monitor, or a physical button. Note that there may be a configuration in which input of various kinds of information to the computer 100 is performed via the communication apparatus 104, which is described below.

The communication apparatus 104 is a communication module for communicating with another apparatus or the internet by using a predetermined communication standard. As the communication method, there is, for example, a wireless LAN (Local Area Network) such as Wi-Fi (Wireless Fidelity), 4G (fourth-generation mobile communication system), broadband, or Bluetooth (registered trademark). The communication apparatus 104 is configured by an apparatus capable of communication using, at least, the input I/F units 51 and 71, the network I/F units 52, 61, and 72, the audio I/F unit 53, and the display I/F unit 62 which are described above.

The output apparatus 105 is an apparatus for outputting various kinds of information from the computer 100. The output apparatus 105 is a display that displays an image or a video, a speaker that outputs a sound, or the like. Note that there may be a configuration in which output of various kinds of information from the computer 100 is performed via the communication apparatus 104.

The control apparatus 101, for example, reads out and executes a program (for example, an application) stored in the storage apparatus 102, to thereby execute various kinds of processing as described above. For example, in the case of the information processing apparatus 5, the 3D audio reproduction software is read out from the storage apparatus 102 and executed to thereby execute processing for the audio reproduction processing unit 54.

Note that a program (for example, an application) does not need to be stored in the storage apparatus 102. For example, there may be adopted a configuration in which the computer 100 reads out and executes a program stored in a storage medium that can be read. For example, this storage medium may be an optical disc, a magnetic disk, a semiconductor memory, an HDD, or the like that can be attached to and detached from the computer 100. In addition, there may be adopted a configuration in which a program (for example, an application) is stored in advance in an apparatus that is connected to a network such as the internet and the computer 100 reads out and executes the program therefrom. For example, each item of software described above may be plug-in software that adds part or all of the processing described above to existing software.

### 7. Modifications

Description has been given above in detail regarding embodiments of the present disclosure, but the present disclosure is not limited to the embodiments described above, and various modifications based on the technical concept of the present disclosure are possible. For example, various modifications such as those described next are possible. In addition, one or more freely-selected modes of the modifications described below can be combined with each other as appropriate. In addition, configurations, methods, steps, shapes, materials, numbers, etc., in the embodiments described above can be combined with each other or interchanged to the extent that the spirit of the present disclosure is not deviated from. Moreover, a singular item can be divided into two or more, and it is also possible to omit a portion thereof.

For example, in the first embodiment described above, there is given an example in which the 3D audio reproduction software provides metadata that includes position information, a signal level, a type of a sound, and other information to video software and the video software uses this information to generate a video, but the information included in the provided metadata and the information used to generate a video is not limited to this. For example, it is sufficient if at least one or more items of information are used to generate a video, such as generating a video with only position information for a sound. In addition, information used to generate a video is not limited to information representing a position of a sound, a signal level, or a type of a sound, and any information may be sent, such as information representing a musical scale or a color for a sound. If there is information that can exhibit an effect in a case of visually representing a sound, it is possible to visually supplement the sound to perform representation.

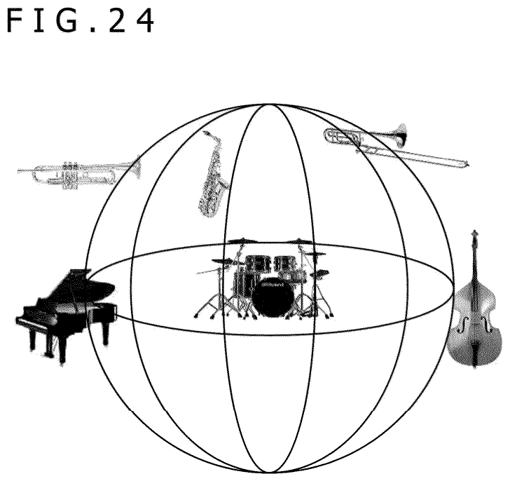

FIG. 24 illustrates a first display example by a display apparatus 4 in a modification. In this example, video software obtains, as metadata, information representing a position of a sound and a type of the sound (specifically, a type of a musical instrument) from 3D audio reproduction software, and uses the obtained information to generate a video in which a musical instrument that corresponds to the type of the sound is disposed in a 3D space. As a result, it is possible to visually supplement the type and disposition of a musical instrument, which are difficult to understand by the sound alone.

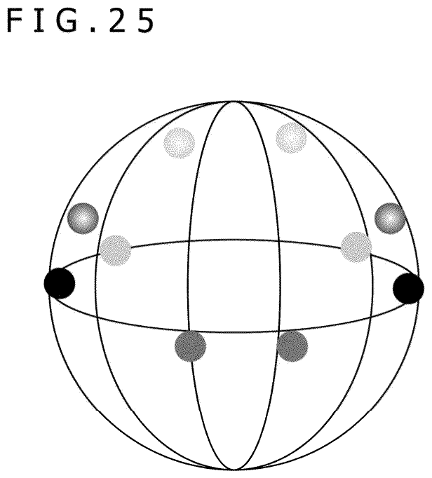

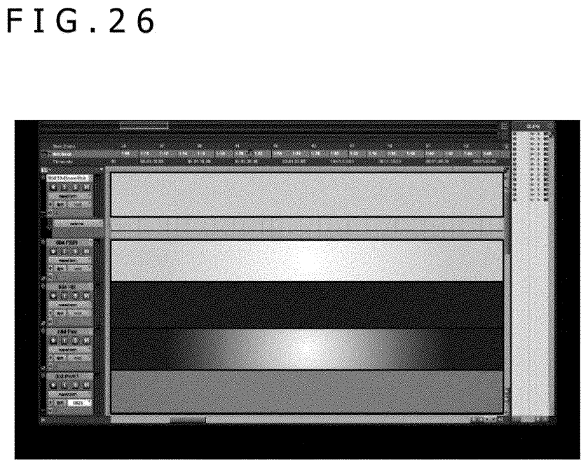

FIG. 25 illustrates a second display example by a display apparatus 4 in a modification. In this example, video software obtains, as metadata, information representing a position for a sound and a color (represented by black and white shading in FIG. 25) for the sound from 3D audio reproduction software, and uses the obtained information to generate a video in which colors are disposed in a 3D space. As a result, it is possible to use a color for depicting a sound to visually supplement the sound. As a setting for a color of a sound, consideration can be given to, for example, visualizing, in an unchanged manner, colors that are allocated to respective sounds in software such as a DAW (Digital Audio Workstation) tool as illustrated in FIG. 26, for example.

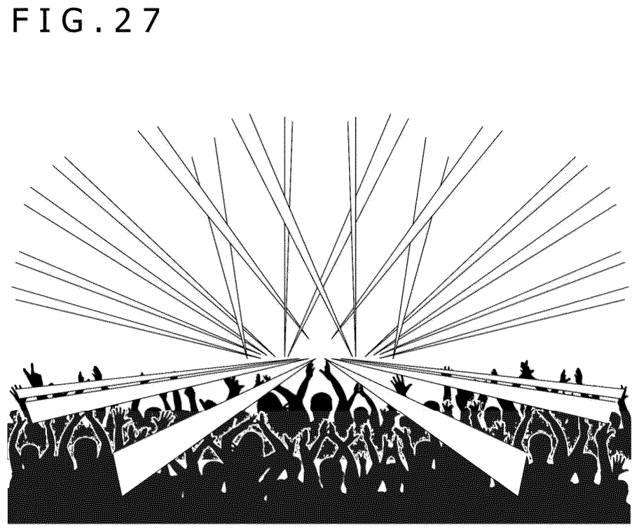

FIG. 27 illustrates a third display example by a display apparatus 4 in a modification. It is sufficient if the display apparatus 4 can stimulate the visual sense of a user, and the display apparatus 4 is not limited to a display apparatus that displays and image and may be, for example, an illumination apparatus (for example, a laser beam apparatus for a performance) as illustrated in FIG. 27, for example. In this case, it is sufficient if illumination states such as motion, brightness, and a color are changed according to visual data generated by video software, for example.

Further, in another example, communication between 3D audio reproduction software and video software is not limited to the one performed by separate devices as in the first embodiment or the one performed by intra-application communication such as between the playback engine and the graphics engine which are within the same application in the same device as in the third embodiment. For example, there may be a mode in which inter-application communication is performed by different applications that are within the same device or other modes.

Moreover, in still another example, in the embodiments described above, a case of decoding a compressed 3D audio sound source file when reproducing 3D audio is exemplified, but there is no limitation to this, and an uncompressed 3D audio sound source file may be read or received unchanged.

Further, in yet another example, in the above-described fourth embodiment, a configuration in which the information processing apparatus 5C which executes 3D audio reproduction software and video software has the sensor 56 is exemplified, but a location where the sensor 56 is provided is not limited to this. For example, the sensor 56 may be employed by itself as a separate sensing device, or may be provided on, for example, a VR/AR/MR viewing device that differs from the information processing apparatus 5C. For example, output information from the sensor 56 may be communicated by a network to the 3D audio reproduction software or the video software.

In addition, in a further example, in the embodiments described above, a configuration in which a video is generated in conjunction with a 3D audio sound is exemplified, but there is no limitation to this. It is sufficient if a video is generated in conjunction with a sound to reproduce and, for example, there can be application to a system that forms a sound field in which a sound expands two-dimensionally, such as a stereo sound. In addition, the information processing systems 1, 1A, 1B, and 10 in the embodiments can be applied to an AV (Audio and Visual) system in a vehicle such as an automobile.

Note that the present disclosure can also have configurations such as the following.

(1)

An information processing apparatus including:
a visual processing unit configured to, at a time of reproducing audio, obtain information pertaining to a sound for the audio, and use the obtained information pertaining to the sound to generate information for visualizing the information pertaining to the sound.
   (2)

The information processing apparatus according to (1), in which
the visual processing unit obtains, in real time, the information pertaining to the sound at the time of reproducing the audio.
   (3)

The information processing apparatus according to (1) or (2), in which
the visual processing unit uses connectionless network communication to receive and obtain the information pertaining to the sound.
   (4)

The information processing apparatus according to any one of (1) to (3), in which
the audio is 3D audio.
   (5)

The information processing apparatus according to (4), in which
the 3D audio is object-based 3D audio, and
acoustic metadata used in reproduction of the object-based 3D audio is used as the information pertaining to the sound.
   (6)

The information processing apparatus according to any one of (1) to (5), in which
the visual processing unit obtains, as the information pertaining to the sound, information representing a position of the sound.
   (7)

The information processing apparatus according to any one of (1) to (6), in which
the visual processing unit obtains, as the information pertaining to the sound, information representing a signal level of the sound.
   (8)

The information processing apparatus according to any one of (1) to (7), in which
the visual processing unit obtains, as the information pertaining to the sound, information representing a type of the sound.
   (9)

The information processing apparatus according to any one of (1) to (8), including:
an audio reproduction processing unit configured to perform processing for the reproduction of the audio,
in which the audio reproduction processing unit provides the information pertaining to the sound to the visual processing unit at the time of reproducing the audio.
   (10)

The information processing apparatus according to (9), in which
the audio reproduction processing unit obtains information representing motion of a user, corrects the information pertaining to the sound on the basis of the obtained information representing the motion of the user, and provides the corrected information pertaining to the sound to the visual processing unit.
   (11)

The information processing apparatus according to (10), in which
the visual processing unit generates information for displaying a VR, AR, or MR image, obtains the information representing the motion of the user, and corrects the generated information for displaying the VP, AP, or MR image on the basis of the obtained information representing the motion of the user.
   (12)

The information processing apparatus according to any one of (9) to (11), in which
the audio reproduction processing unit obtains information that corresponds to an operation performed by a user, rewrites the information pertaining to the sound on the basis of the obtained information that corresponds to the operation performed by the user, controls the reproduction of the audio, and provides the rewritten information pertaining to the sound to the visual processing unit.
   (13)

An information processing system including:
an audio reproduction processing unit configured to perform processing for reproduction of audio; and
a visual processing unit configured to perform processing for generating visual data,
in which, the audio reproduction processing unit transmits information pertaining to the sound to the visual processing unit at a time of reproducing the audio, and
the visual processing unit receives the information pertaining to the sound from the audio reproduction processing unit, and uses the received information pertaining to the sound to generate visual data for visualizing the information pertaining to the sound.
   (14)

An information processing method including:
at a time of reproducing audio, obtaining information pertaining to a sound for the audio, and using the obtained information pertaining to the sound to generate information for visualizing the information pertaining to the sound.
   (15)

A program for causing a computer to execute:
processing for, at a time of reproducing audio, obtaining information pertaining to a sound for the audio, and using the obtained information pertaining to the sound to generate information for visualizing the information pertaining to the sound.

### REFERENCE SIGNS LIST

1, 1A, 1B, 10: Information processing system
2: Controller
3: Audio output apparatus
4: Display apparatus
5, 5A, 5B, 5C, 6, 7: Information processing apparatus
54, 54A, 54B, 54C: Audio reproduction processing unit
55, 55A, 63: Visual processing unit
56: Sensor

1. An information processing apparatus comprising:
a visual processing unit configured to, at a time of reproducing audio, obtain information pertaining to a sound for the audio, and use the obtained information pertaining to the sound to generate information for visualizing the information pertaining to the sound.

2. The information processing apparatus according to claim 1, wherein
the visual processing unit obtains, in real time, the information pertaining to the sound at the time of reproducing the audio.

3. The information processing apparatus according to claim 1, wherein
the visual processing unit uses connectionless network communication to receive and obtain the information pertaining to the sound.

4. The information processing apparatus according to claim 1, wherein
the audio is 3D audio.

5. The information processing apparatus according to claim 4, wherein
the 3D audio is object-based 3D audio, and
acoustic metadata used in reproduction of the object-based 3D audio is used as the information pertaining to the sound.

6. The information processing apparatus according to claim 1, wherein
the visual processing unit obtains, as the information pertaining to the sound, information representing a position of the sound.

7. The information processing apparatus according to claim 1, wherein
the visual processing unit obtains, as the information pertaining to the sound, information representing a signal level of the sound.

8. The information processing apparatus according to claim 1, wherein
the visual processing unit obtains, as the information pertaining to the sound, information representing a type of the sound.

9. The information processing apparatus according to claim 1, comprising:
an audio reproduction processing unit configured to perform processing for the reproduction of the audio,
wherein the audio reproduction processing unit provides the information pertaining to the sound to the visual processing unit at the time of reproducing the audio.

10. The information processing apparatus according to claim 9, wherein
the audio reproduction processing unit obtains information representing motion of a user, corrects the information pertaining to the sound on a basis of the obtained information representing the motion of the user, and provides the corrected information pertaining to the sound to the visual processing unit.

11. The information processing apparatus according to claim 10, wherein
the visual processing unit generates information for displaying a VR, AR, or MR image, obtains the information representing the motion of the user, and corrects the generated information for displaying the VR, AR, or MR image on the basis of the obtained information representing the motion of the user.

12. The information processing apparatus according to claim 9, wherein
the audio reproduction processing unit obtains information that corresponds to an operation performed by a user, rewrites the information pertaining to the sound on a basis of the obtained information that corresponds to the operation performed by the user, controls the reproduction of the audio, and provides the rewritten information pertaining to the sound to the visual processing unit.

13. An information processing system comprising:
an audio reproduction processing unit configured to perform processing for reproduction of audio; and
a visual processing unit configured to perform processing for generating visual data,
wherein the audio reproduction processing unit transmits information pertaining to the sound to the visual processing unit at a time of reproducing the audio, and
the visual processing unit receives the information pertaining to the sound from the audio reproduction processing unit, and uses the received information pertaining to the sound to generate visual data for visualizing the information pertaining to the sound.

14. An information processing method comprising:
at a time of reproducing audio, obtaining information pertaining to a sound for the audio, and using the obtained information pertaining to the sound to generate information for visualizing the information pertaining to the sound.

15. A program for causing a computer to execute:
processing for, at a time of reproducing audio, obtaining information pertaining to a sound for the audio, and using the obtained information pertaining to the sound to generate information for visualizing the information pertaining to the sound.
